(19) United States
(12) Patent Application Publication
(10) Pub. No.: US 2025/0274439 A1
(43) Pub. Date: Aug. 28, 2025

(54) SYSTEM AND METHOD FOR COLLECTING EVIDENCES FROM A PRIVATE INFRASTRUCTURE

(71) Applicant: Anecdotes.ai, LTD, Tel Aviv (IL)

(72) Inventors: Michael KIPNIS, Rishon LeTsiyon (IL); Omri ROSNER, Tel Aviv (IL); Roni ALTSHULER, Tel Aviv (IL); Alon MORGENSTERN, Yavne (IL); Or YAGEL, Herzliya (IL)

(73) Assignee: Anecdotes.ai, LTD, Tel Aviv (IL)

(21) Appl. No.: 18/603,785

(22) Filed: Mar. 13, 2024

Related U.S. Application Data
(60) Provisional application No. 63/558,968, filed on Feb. 28, 2024.

(51) Int. Cl. H04L 9/40

(52) U.S. Cl. CPC H04L 63/029; H04L 63/10

(57) ABSTRACT

A system and method for collecting evidence from a private computing infrastructure is provided. The method includes establishing at least one secure tunnel with a user system of the private computing infrastructure through an agent; initiating an evidence collection over the at least one secure tunnel, wherein initiating the evidence collection further comprises fetching tunnel details; accessing the user system via a first tunnel of the least one secure tunnel, wherein the first tunnel is active and identified from the fetched tunnel details; and collecting raw data of evidence from the user system.

### CROSS-REFERENCE TO RELATED APPLICATIONS

This application claims the benefit of U.S. Provisional Application No. 63/558,968 filed on Feb. 28, 2024, the contents of which are hereby incorporated by reference.

### TECHNICAL FIELD

The present disclosure relates generally to security compliance, particularly for collecting evidences of compliance from a closed, private computing infrastructure.

### BACKGROUND

Government, Risk, and Compliance (GRC) strategy is adopted and integrated in many organizations, big and small, in order to achieve organization objectives. Here, Compliance indicates the organization's compliance with requirements of internal and/or external guidelines, also referred to as frameworks. Frameworks are widely accepted guidelines or standards that are established by external organizations for individuals, organizations, or the like to adhere to, in order to protect data that are handled and utilized. Common frameworks include, for example, but not limited to, Security and Compliance Standard (SOC), Health Insurance Portability and Accountability Act (HIPAA), Payment Card Industry Data Security Standard (PCI DSS), and the like. Stakeholders may leverage such frameworks to gauge the validity and/or security of the organization. Incompliance with frameworks can lead to adverse effects such as financial penalties, loss of operating licenses, investigations, and more.

Thus, compliance of present and future processes, as well as activities to address such compliance requirements may be key features for maintenance and healthy growth of the organization. Organizations can implement compliance programs that include tools, strategies, and the like, to ensure compliance at different stages and with frameworks. Based on their business sector, the organization may be more concerned with one framework over another. In many cases, organizations may be concerned about the organization's compliance with one or more frameworks.

It has been identified that evidences may be collected from all parts of the organization to determine compliance. Evidences are data or documents such as, but not limited to, policies, manuals, standard operation procedures, regulatory mandates, training records, and the like, and more that suggest a compliance state (or posture) of the organization.

Currently implemented techniques often rely on manual pulling of evidences, which are limited to isolated auditing and checking off of boxes in a list of audit requirements. The technique is manually performed at a specific time of need (e.g., before an audit, at reporting season, and the like). The static nature of the current techniques does not capture the ever-changing, exponential growth of the organization within and in relation to third-party entities. That is, compliance analyses and postures determined using currently implemented techniques may be limited in scope and out of date to provide inaccurate analyses of the organization's compliance.

In order to provide accurate and encompassing analyses of compliance, evidences may be pulled from different portions of the organization's infrastructure, which may operate in a cloud (e.g., a private cloud, a public cloud, and/or a hybrid cloud), a local server or hardware, and the like, and any combination thereof. However, effective collection from infrastructures with different configurations as well as compatibility with them still remain a challenge. In particular, evidence collection from closed infrastructures that may handle sensitive data is concerning with respect to security of data, transmission of data, accessibility, and more.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for collecting evidence from a private computing infrastructure. The method comprises: establishing at least one secure tunnel with a user system of the private computing infrastructure through an agent; initiating an evidence collection over the at least one secure tunnel, wherein initiating the evidence collection further comprises fetching tunnel details; accessing the user system via a first tunnel of the least one secure tunnel, wherein the first tunnel is active and identified from the fetched tunnel details; and collecting raw data of evidence from the user system.

Certain embodiments disclosed herein also include a non-transitory computer readable medium having stored thereon causing a processing circuitry to execute a process, the process comprising: establishing at least one secure tunnel with a user system of the private computing infrastructure through an agent; initiating an evidence collection over the at least one secure tunnel, wherein initiating the evidence collection further comprises fetching tunnel details; accessing the user system via a first tunnel of the least one secure tunnel, wherein the first tunnel is active and identified from the fetched tunnel details; and collecting raw data of evidence from the user system.

Certain embodiments disclosed herein also include a system for collecting evidence from a private computing infrastructure. The system comprises: a processing circuitry; and a memory, the memory containing instructions that, when executed by the processing circuitry, configure the system to: establish at least one secure tunnel with a user system of the private computing infrastructure through an agent; initiate an evidence collection over the at least one secure tunnel, wherein initiating the evidence collection further comprises fetching tunnel details; access the user system via a first tunnel of the least one secure tunnel, wherein the first tunnel is active and identified from the fetched tunnel details; and collect raw data of evidence from the user system.

Certain embodiments disclosed herein include the method, non-transitory computer readable medium, or system noted above or below, further including or being configured to perform the following step or steps: terminating the access via the first tunnel upon collection of raw data; and purging the fetched tunnel details of the access.

Certain embodiments disclosed herein include the method, non-transitory computer readable medium, or system noted above or below, further including or being configured to perform the following step or steps: storing the raw data of the evidence in at least a portion of a data store, wherein the portion of the data store is dedicated to a tenant of the private computing infrastructure.

Certain embodiments disclosed herein include the method, non-transitory computer readable medium, or system noted above or below, wherein initiating the evidence collection is based on any one of: a predetermined schedule and an on-demand request.

Certain embodiments disclosed herein include the method, non-transitory computer readable medium, or system noted above or below, wherein the evidence includes at least one of: a policy, a standard operation procedure, an audit trail, an audit log, a training record, an incident response plan, a change management policy, a risk assessment, a third-party agreement, and a user system configuration.

Certain embodiments disclosed herein include the method, non-transitory computer readable medium, or system noted above or below, further including or being configured to perform the following step or steps: receiving a query from the agent for a network configuration at the query; and causing the agent to activate at least one secure tunnel of the at least one established secure tunnel based on the network configuration at the query.

Certain embodiments disclosed herein include the method, non-transitory computer readable medium, or system noted above or below, further including or being configured to perform the following step or steps: assigning a range of ports of the at least one secure tunnel to the private computing infrastructure; receiving credentials for the user system; and storing the assigned range of ports and the received credentials.

Certain embodiments disclosed herein include the method, non-transitory computer readable medium, or system noted above or below, wherein the established at least one secure tunnel is utilized for a plurality of accesses to the user system.

Certain embodiments disclosed herein include the method, non-transitory computer readable medium, or system noted above or below, further including or being configured to perform the following step or steps: determining a compliance state for the user system based on the collected raw data of the evidence with respect to at least one framework.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for collecting evidence data from a closed user system according to an embodiment.

FIG. 3 is a schematic diagram of a collector system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for securely and effectively collecting an evidence from a closed system by establishing and utilizing a secure tunnel. The closed system may be a private cloud or an on-premise infrastructure that is not connected to the network (e.g., the Internet) in order to, for example, reduce security risks. The secure tunnel is established as a secure and sole connection to access the closed user system in the tenant cloud. The tunnel, of the disclosed embodiments, is established between a collector system and the user system by deploying an agent at the tenant cloud in a vicinity to the closed user system. The communication over the tunnel is performed using an assigned tunnel (or port) that is dedicated to the tenant, the user system, and/or a plugin (e.g., service, application, or the like) and authenticated before the collector system has access to the tunnel and into the user system. The disclosed embodiments enable secure and continuous access into the closed user system to collect evidences of compliance therefrom. It should be noted that the tunnel provides a steady connection that is secure and readily accessible to collect evidences from an otherwise closed system. It should be further noted that the recurrent collection over the tunnel enables on-going analyses of compliance of the user system and the tenant entity against one or more framework.

It has been identified that configuration of firewalls that filter out potential malicious network traffics are not only complex but may cause unpredicted security risks. In some implementations, firewalls may be deployed in multiple layers for protection of the tenant cloud, as well as various components in the cloud to add complications. The embodiments disclosed herein utilize the agent deployed at the tenant cloud to avoid such configuration of the firewall with respect to the network, thereby preventing security risks. The agent is installed and run at the tenant cloud to maintain the established tunnel by, for example, but not limited to, pulling current network configurations, opening or closing tunnels based on the current network configuration and a private key, and the like, and more. To this end, the tunnel established through the agent provides tenant control over the connection to the collector system. That is, the authorization and authentication for accessing the closed user system is governed from the tenant side and not an external source, such as the collector system. It should be appreciated that the disclosed embodiments prevent other external sources from accessing, or even attempting to access, the user system, thereby adding a level of security and control over the data in the user system.

In addition, the embodiments disclosed herein provide a secure tunnel that is established and maintained for continuous or ad hoc access and collection of evidence data. In an embodiment, raw data of evidences are readily collected from the user system for compliance tests against one or more frameworks. The raw data of evidence may be collected once and applied to rules of multiple framework to reduce network traffic between the collector system and the tenant cloud and processing thereof. It should be noted that evidences of compliance may continuously change at the user system and/or plugins, and thus, regular monitoring and analyses of evidences are advantageous to effectively and efficiently determine compliance states (or compliance postures) with respect to various frameworks. It should be further noted that guidelines for frameworks may also change, and thus, the disclosed embodiments allow compliance states to be determined with respect to the most current guidelines of the framework.

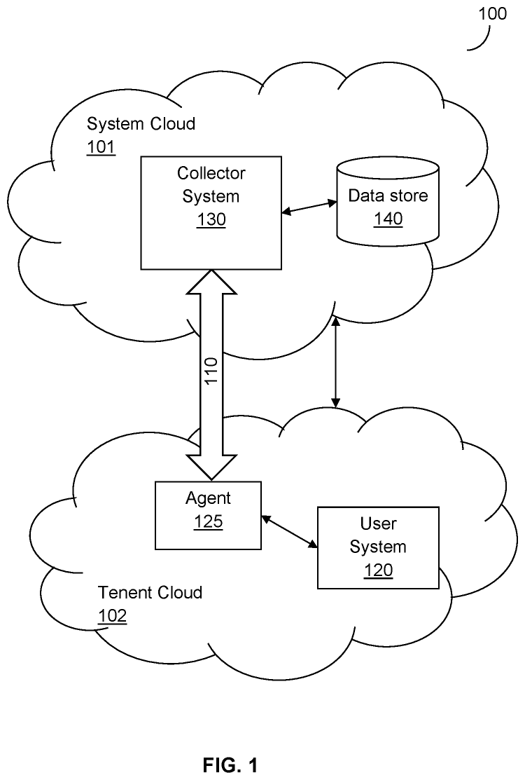

FIG. 1 shows an example network diagram 100 utilized to describe the various disclosed embodiments. In the example network diagram 100, a system cloud 101, that includes a collector system 130 and a data store 140, and a tenant cloud 102. that includes a user system 120 and an agent 125, communicates via a network. The network may be but is not limited to, a wireless, cellular, or wired network, a local area network (LAN), a wide area network (WAN), a metro area network (MAN), the Internet, the worldwide web (WWW), similar networks, and any combination thereof.

The tenant cloud 102 may be a cloud computing environment of resources utilized by the particular tenant (or vendor) entity in a private cloud, a hybrid cloud, or a public cloud. The tenant cloud 102 is configured with at least the user system 120 and the agent 125. The tenant cloud 102 may be dedicated to a single tenant or may be configured to serve multiple tenants.

The user system 120 may be a component, a server, a system, a device, an infrastructure, or the like including, for example, but not limited to, a private cloud, a virtual private cloud (VPC), an on-premise infrastructure, and the like. The user system 120 operates within the tenant cloud 102 and is closed from communication with external entities such as, but not limited to, cloud system, servers, or the like, that are not associated with the tenant entity. That is, the user system 120 is a closed system that has limited or no access by external entities. As an example, such a user system 120 may handle sensitive customer information to be kept closed for potential security issues.

The user system 120 may be deployed with one or more plugins (e.g., service, application, etc.), which may be referred to as integrations. The plugin may be a software component that operates to provide, for example, but not limited to, cloud infrastructure, development tools, organizational tools, identity providers, human resource tools, security tools, and the like, and more. The plugin may be accessed via an Application Programming Interface (API). Each plugin in the user system 120 includes a plurality of evidences of compliance (or simply referred to as evidences herein) as raw data that may be collected and utilized for compliance analyses for the tenant entity of the tenant cloud 102 as a whole and/or with respect to the respective plugin.

It should be noted that the user system 120 is configured to be closed from external access and thus, collection of the plurality of evidences in the user system 120 may be restricted. In some implementations, one or more firewalls are deployed in the tenant cloud 102 and/or the user system 120 for protection against potential malicious attacks through network traffic.

The agent 125 is deployed in the tenant cloud 102 to establish and maintain a secure connection via a tunnel 110 between the tenant cloud 102 and the system cloud 101. The agent 125 may be realized as a piece of code stored, for example, in a memory (not shown) in the tenant cloud 102 and executed. In an embodiment, the tunnel 110 is configured as a secure connection between the closed user system 120 and the collector system 130 via the agent 125, acting as a proxy to relay traffic into the internal system (i.e., the user system 120). The tunnel 110 may be a sole connection into the otherwise closed user system 120 and may be utilized by the specific entity of the system cloud 101, thereby preventing potentially malicious attacks from unknown external sources. In an embodiment, the agent 125 deployed at the tenant cloud 102 is executed to establish a secure connection without configuring one or more firewalls. The firewalls at the tenant cloud 102 may open, for example, a single port to the collector system 130. A plurality of evidences of compliance from the plurality of plugins in the user system 120 may be provided to the collector system 130 via the agent 125.

According to the disclosed embodiments, the agent 125 is configured to repeatedly query and fetch network configurations from the collector system 130 to maintain a secure and current connection via the tunnel 110. The repeated querying and fetching, or together referred to as pulling, of network configuration may be performed intermittently, periodically, or the like. In an example embodiment, the pulling is performed over a Hypertext Transfer Protocol Secure (HTTPS) protocol and is authorized using an agent application programming interface (API) key. In a further example embodiment, the agent API key may be utilized at the collector system 130 to identify the agent 125 that queries for pulling. The agent 125 requests network configuration to the collector system 130 which, in return, provides a private key and tunnel details for the connection. The tunnel details may include, for example, but are not limited to, port number, port to open, port to close and the like, and any combination thereof. As an example, the tunnel details may include all secure tunnels set up between the collector system 130 and the user system 120, their port numbers, and their connection status (e.g., open or close). The agent 125 then opens identified tunnels based on the received private key and the tunnel details in order to allow active communication via the tunnel 110. In an embodiment, the tunnel 110 is an SSH tunnel and a SSH private key is provided to open connections.

Any changes in the network configurations may be detected at the agent 125, by the repeated pulling, and implemented. As an example, when the agent 125 fetches tunnel details that indicate opening of a first tunnel and closing a second tunnel, the agent 125 may close the second tunnel that is currently opened and, instead, open the first tunnel for communication. In another example, when a new SSH private key is received, the open tunnels are reopened with the new SSH private key. It should be noted that the opening of the tunnel 110 is performed and managed by the agent 125. To this end, the agent 125 enables tenant side control over the opening and closing of tunnels to prevent unknown connections to internal components as well as to shut down inactive tunnels to reduce connection, thereby reducing computing burden and potential network attacks.

The private key and the tunnel details are unique for the tenant entity (or vendor entity) and/or user system. In an embodiment, a range of ports of the collector system 130 and the agent 125 is assigned to the tenant cloud 102 and further, a specific port is assigned to the user system 120. In a further embodiment, each of the one or more plugins in the user system 120 may be assigned with a unique port for communication through the tunnel 110. It should be noted that such assignment and private key allow isolated and authorized connection between the collector system 130 and the user system 120 via the tunnel 110.

The dedicated tunnels (i.e., ports) are created at the collector system 130 at installation based on information from the tenant entity. As an example, 100 ports may be created for a tenant cloud 102. The tenant entity selects and provides information such as, but not limited to, hostname, ports of the user system 120, credentials (e.g., API credentials), permissions, and the like, and any combination thereof, of the user systems 120 and/or plugins that are subject to compliance monitoring. Thus, the tunnel details are empty at installation when dedicated tunnels are not yet created.

The agent 125 is further configured to generate logs for events that are executed. The log may include a record of events such as, but not limited to, pulling and opening of tunnels, the tunnel details, periodic heartbeat, evidence collection process, and the like, and any combination thereof. The generated logs may be stored in a memory and/or database (not shown) at the tenant cloud 102. In an embodiment, at least portions of the generated logs may be provided to the collector system 130 of the system cloud 101 for information on the agent.

It should be noted that a single user system 120 and a single agent 125 are shown in FIG. 1 for simplicity and does not limit the scope of the disclosed embodiments. The tenant cloud 102 may be configured with one or more user systems 120, which may include common plugins. The user systems 120 may operate independently from each other. In some implementations, the one or more user systems 120 may communicate with one another as part of the larger tenant cloud, but not with external entities. Moreover, a plurality of agents 125 may be deployed at the tenant cloud 102, acting as proxies to manage communication and data transmission (e.g., evidences of compliance) from the user systems 120 to the collector system 130 via the tunnel 110.

The collector system 130 is a component, a server, a device, a system, or the like configured to collect evidences of compliance from the tenant cloud 102. The collector system 130 queries and receives raw data of evidences through the open tunnel 110 for further compliance analyses. In an embodiment, the collection of evidences, to query and receive, may be initiated according to a predetermined schedule. In a further embodiment, the collection of evidence may be initiated on demand. The query for access to evidences is submitted via an API at the user system 120. The access may be permitted in the presence of API credentials of the user system 120 at the system cloud 101, for example, at a database (not shown). According to the disclosed embodiments, the collector system 130 accesses the user system 120 via the secure tunnel 110. As noted above, the collector system 130 may create dedicated tunnels of a range of ports for the tenant cloud 102 and specific ports for its internal system, such as the user system 120. That is, the collector system 130 collects the evidences of compliance from the user system 120 using the open tunnel. The tunnel 110 is opened and maintained by the agent 125. It should be noted that the collector system 130 connected via the tunnel 110 may be the sole connection with the, otherwise closed, user system 120.

The collected raw data of evidence may be stored in a bucket within the collector system 130 that is designated for the tenant entity. In an embodiment, the designated bucket including the collected raw data may be in a data store 140. The collection session may be defined, for example, as a predetermined time window. In an embodiment, the evidences of compliance may be collected as raw data per tenant entity, per system, and per account. The tenant entity may include one or more accounts that are connected and monitored by the collector system 130 for evidence collection. Thus, the collected raw data are separately collected and stored without shared memory and/or resources. The collector system 130 may include a server instance with a static Internet Protocol (IP) address, which may run for each collection session. Upon completing collection at each collection session, the connection may be terminated. In an embodiment, data relevant to the collection session such as, but not limited to, fetched credentials, the tunnel details, private key, and the like, may be discarded when the session ends.

The evidences may be data and/or documents that are relevant to framework compliance and include, for example, but not limited to, policies, standard operation procedures, audit trails and logs, training records, incident response plans, change management policies, risk assessment, third-party agreements, user system 120 (or plugin) configuration, and the like, and any combination thereof. The raw data of evidences are analyzed by applying rules of a framework in order to determine a compliance state of the plugin with respect to the framework. The framework is a set of predetermined guidelines including regulations, standards, rules, auditing procedures, and the like, and any combination thereof for information security that are widely adopted by individuals, organizations, vendors, or the like. It has been identified that compliance with such frameworks is an essential factor for the operation of an organization. Some examples of established frameworks include, without limitations, Security and Compliance Standard (SOC), Health Insurance Portability and Accountability Act (HIPAA), International Organization for Standards (ISO) 27001, and the like, and more. As an example, a success/failure of an evidence with respect to the rules of the SOC framework may be determined. The raw data of evidences collected for the tenant may be associated with metadata such as, but not limited to, tenant name or identifier (ID), instance ID, user system ID, collection time, test result (e.g., success or failure), and the like and stored in the data store 140 or a database (not shown).

It should be noted that a plurality of tenant clouds 102 may communicate with the system cloud 101. In some implementations, a plurality of data stores 140 may be present in the system cloud 101, each data store assigned to a specific tenant entity of a tenant cloud of the plurality of tenant clouds.

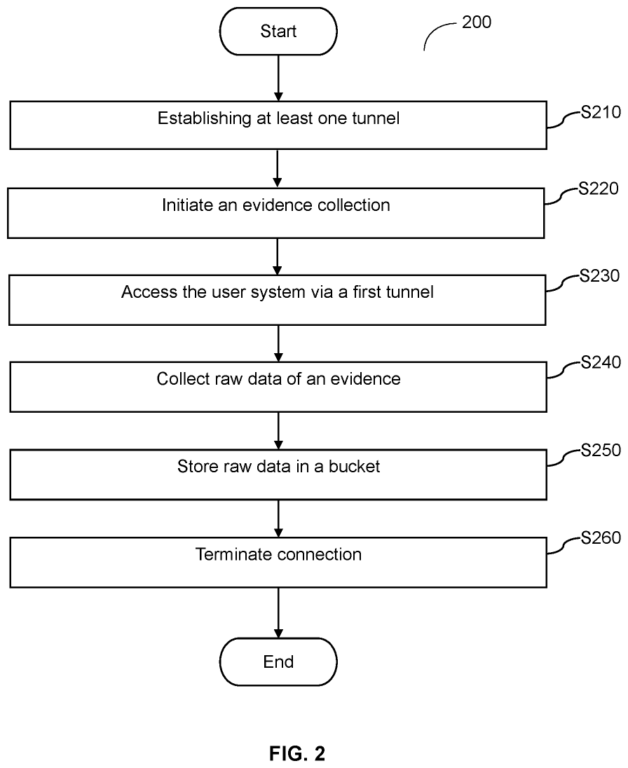

FIG. 2 is an example flowchart 200 illustrating a method for collecting raw data of evidences of compliance according to an embodiment. The method described herein is performed in the collector system 130, FIG. 1. The raw data is collected over a secure tunnel (e.g., the tunnel 110, FIG. 1) between a user system 120 and the collector system 130. It should be noted that the collection of raw data of evidence may be performed per tenant, per integrated system (e.g., the user system 120, FIG. 1, a plugin of the user system 120), and per account, thereby avoiding shared memory or resource for the collection.

At S210, at least one secure tunnel is established with a user system. The at least one secure tunnel is established to connect the collector system to the user system (e.g., the user system 120, FIG. 1) in a tenant cloud (e.g., the tenant cloud 102, FIG. 1) through an agent (e.g., the agent 125, FIG. 1) deployed at the tenant cloud. The agent is a piece of code deployed and executed at the tenant cloud that monitors and manages access and communication over the secure tunnel. In an embodiment, the at least one secure tunnel includes a range of dedicated ports for the tenant and a dedicated port for the user system. In a further embodiment, the secure tunnel may be an SSH tunnel with an associated SSH key for authenticating access and data transmission through the respective secure tunnel. It should be noted that the secure tunnel is established without network configuration (e.g., opening to the Internet) of one or more firewalls in the tenant cloud, thereby reducing complexity and potential breaching of security. In an embodiment, a specific firewall port is opened out to the collector system for connecting the secure tunnel.

At an initial establishment of the connection, the at least one tunnel, including at least one dedicated port, and a private key is generated for a tenant entity. The agent is installed at the tenant cloud to connect with the collector system through the tunnel. The collector system receives user system information such as, but not limited to hostname, port, credentials, permissions, and the like, and any combination thereof. The received information is utilized to create dedicated tunnel configurations for the secure tunnel that connects to the respective user system, to establish a complete connection from the collector system, through the agent, and the respective user system. Such received information may be stored in a database (not shown) at the collector system side (e.g., the system cloud 101) and may be retrieved for authorizing access and communication over the secure tunnel for evidence collection. The user system credentials may have API credentials of the user system 120 that are provided by the tenant entity during the initial set-up. In an embodiment, the user system credentials (e.g., API credentials) are stored in a secured storage. Examples of the secure storage may include, and without limitation, a secret manager, a secure vault, or the like. It should be noted that the user system credentials stored and fetched within the system cloud are an authentication by the tenant entity to permit evidence collection from the user system of the tenant entity. That is, evidence collection cannot be performed without the user system credentials at the collector system.

It should be noted that once the secure tunnel has been established, the tunnel remains as a secure connection between the collector system and the user system for access. It should be further noted that the secure tunnel may not be established or opened for data access without the involvement of the tenant entity (e.g., personnel to provide system information, agent to open the specific tunnel and allow connection, etc.).

At S220, evidence collection is initiated. User system credentials for the user system (or plugins of the user system such as a service, an application, etc.) and tunnel details specific to the user system are fetched. The tunnel details may include, for example, but are not limited to, port number, port to open, and the like, that is assigned to the user system for which evidence collection is initiated. The credentials and/or the tunnel details may be stored in a database (not shown) within the system cloud (e.g., the system cloud 101, FIG. 1). As noted above, such information may be stored during the initial establishment of the at least one tunnel (S210). In an embodiment, the fetched credentials, tunnel details, and the like associated with the initiated evidence collection session may be stored in temporary memory. In a further embodiment, the temperate memory includes segregated buckets for each tenant entity.

In an embodiment, the initiation of evidence collection may be performed according to a predetermined schedule. The predetermined schedule may be defined for each tenant (or vendor) entity to initiate collection from all integrated user systems of the tenant. In another example embodiment, the predetermined schedule may be defined for a subset of user systems of the tenant. As an example, the evidence collection for a tenant may be performed once per week on a specific day and time, which initiates evidence collection for all integrated user systems of the tenant. In another embodiment, the evidence collection may be initiated by an on-demand request from a user of the tenant entity. Authorized personnel of the tenant entity may request initiation via an API gateway (not shown) with authentication, which initiates the collection based on the request. The initiation request may include details on one or more user systems to be specifically called for evidence collection. In an embodiment, the collection of raw data is performed separately, for example, at dedicated instances for the user system, regardless of being initiated individually or in conjunction. A list of all user systems may be stored and updated as the integrated user system of the tenant changes. In an example embodiment, the tenant entity provides updates on the integrated user system (e.g., the user system credentials) to the collector system.

At S230, the user system is accessed via a first tunnel. The first tunnel is a dedicated tunnel (or port) for the user system as indicated in the tunnel details that are fetched with the initiation. The tunnel details and the credentials (e.g., API credentials of the user system) are utilized for secure, authorized access to the user system. It should be noted that the at least one tunnel is established (S210) and remains established between the collector system and the user system, but access into the user system via a specific tunnel is enabled by connecting to the first tunnel using the fetched tunnel details and the private key. In an example embodiment, the at least one tunnel remains established with respect to a server at the collector system.

In an embodiment, maintaining and managing the at least one tunnel is performed by the agent (e.g., the agent 125, FIG. 1) at the tenant side. The agent is configured to intermittently pull network configurations from the collector system to manage, for example, but not limited to, opening and closing of appropriate tunnels (or ports). The pulling as well as managing of tunnels by the agent operates independently from the process of evidence collection. That is, the opening of a port may not be triggered by the initiation of evidence collection. In an embodiment, the agent has an agent API key that is utilized to identify the agent during pulling. The agent API key may be uniquely assigned to a tenant entity.

At S240, raw data of an evidence is collected from the accessed user system. The raw data of the evidence includes data relating to compliance with various frameworks. The raw data of the evidence include data that may be applied to rules of various frameworks to determine respective compliance state. In an example embodiment, the raw data may not include a compliance state to a specific framework but rather data that that relates to compliance guidelines and may be utilized to determine compliance states for various frameworks through the analyses at the collector system. The raw data may be collected from the evidence such as, but not limited to, policies, standard operation procedures, audit trails and logs, training records, incident response plans, change management policies, risk assessment, third-party agreements, user system configuration, and the like, and any combination thereof, that are available in the accessed user system. As noted, the evidence may be data and/or documents that are relevant to and may indicate compliance with one or more framework guidelines. In an embodiment, the collection of evidences is performed as separate instances for each tenant, each user system, and each account, thereby preventing sharing of memory or resources between them. It should be noted that such segregation enables the secure collection of evidence data from various plugins, user systems, accounts, tenant clouds, tenant entities, and the like.

At S250, the collected raw data of evidence is stored in a bucket. The bucket may be a portion, a whole, or both of a data store (e.g., the data store 140, FIG. 1) and is dedicated to the respective tenant entity. It should be noted that the collected raw data are separately and securely stored for the tenant entity.

At S260, the access to the user system is terminated and the collection session is ended. The access through the first tunnel is terminated upon collecting raw data of the evidence. The decision to stop collection and stop access may be determined by, for example, a predetermined time period for collection, a lower threshold transmission rate, a threshold transmission volume, or the like. In an embodiment, all data such as, but not limited to, tunnel details, private key, user system credentials (or plugin credentials), logs, and the like, may be purged from the temporary memory. Such data are related to each collection session and thus, are discarded upon termination. It should be noted that such clean-up of session-related data (particularly indicating connection to the user system) ensures secure connection via the tunnels. In an example embodiment, a server instance for evidence collection may be terminated. It should be noted that termination of access does not disengage the connection (i.e., tunnel) between the collector system and the user system via the agent. The connection remains established in order to allow the collection of evidences upon initiation.

In an embodiment, the raw data of the evidence may be analyzed with respect to at least one framework to determine a compliance state (or test result) such as, but not limited to, ready for audit, approved, gap, and the like, and any combination thereof. It should be noted that the raw data collected from a single evidence collection process may be used to determine compliance states for more than one framework. That is, repeated evidence collection is avoided, thereby reducing computing resources in memory and power. Metadata for the raw data may be generated including, for example, but not limited to, tenant name or identifier (ID), instance ID, user system ID, collection time, test result (e.g., success or failure), and the like and stored in the data store 140 or a database (not shown). The evidence (e.g., raw data, metadata, and the like) may be stored in the data store (e.g., the data store 140, FIG. 1). In some implementations, the evidence is stored with respect to an ambiguous unique identifier.

According to the disclosed embodiments, steps S220 through S260, which describe a collection session, may be repeated for each initiation of evidence collection. In an example embodiment, these steps are run in a dedicated server instance in the collector system. The process is described with respect to a single component of the plugin, user system, agent, tenant, and the like for simplicity. It should be noted that there may be evidence collections being performed simultaneously for a plurality of components. It should be further noted that the segregated ports, tunnels, server instances, and the like, allow protected evidence collection without mix-ups.

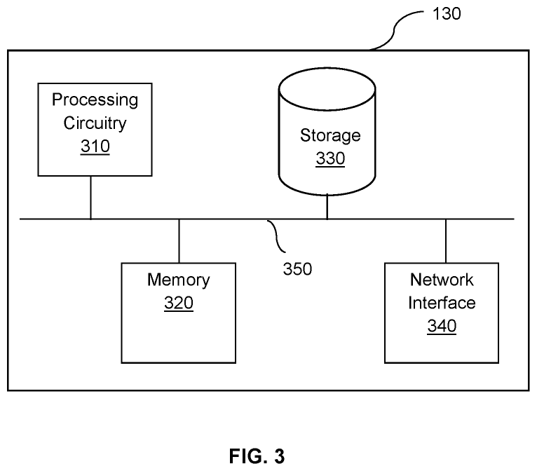

FIG. 3 is an example schematic diagram of a collector system 130 according to an embodiment. The collector system 130 includes a processing circuitry 310 coupled to a memory 320, a storage 330, and a network interface 340. In an embodiment, the components of the collector system 130 may be communicatively connected via a bus 350.

The processing circuitry 310 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 320 may be volatile (e.g., random access memory, etc.), non-volatile (e.g., read only memory, flash memory, etc.), or a combination thereof.

In one configuration, software for implementing one or more embodiments disclosed herein may be stored in the storage 330. In another configuration, the memory 320 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 310, cause the processing circuitry 310 to perform the various processes described herein.

The storage 330 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 340 allows the collector system 130 to communicate with other systems, devices, components, applications, or other hardware or software components, for example as described herein.

It should be understood that the embodiments described herein are not limited to the specific architecture illustrated in FIG. 3, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for collecting evidence from a private computing infrastructure, comprising:
establishing at least one secure tunnel with a user system of the private computing infrastructure through an agent;
initiating an evidence collection over the at least one secure tunnel, wherein initiating the evidence collection further comprises fetching tunnel details;
accessing the user system via a first tunnel of the at least one secure tunnel, wherein the first tunnel is active and identified from the fetched tunnel details; and
collecting raw data of evidence from the user system.

2. The method of claim 1, further comprising:
terminating the access via the first tunnel upon collection of raw data; and
purging the fetched tunnel details of the access.

3. The method of claim 1, further comprising:
storing the raw data of the evidence in at least a portion of a data store, wherein the portion of the data store is dedicated to a tenant of the private computing infrastructure.

4. The method of claim 1, wherein initiating the evidence collection is based on any one of: a predetermined schedule and an on-demand request.

5. The method of claim 1, wherein the evidence includes at least one of: a policy, a standard operation procedure, an audit trail, an audit log, a training record, an incident response plan, a change management policy, a risk assessment, a third-party agreement, and a user system configuration.

6. The method of claim 1, further comprising:
receiving a query from the agent for a network configuration at the query; and
causing the agent to activate at least one secure tunnel of the at least one established secure tunnel based on the network configuration at the query.

7. The method of claim 1, wherein establishing the at least one secure tunnel further comprises:
assigning a range of ports of the at least one secure tunnel to the private computing infrastructure;
receiving credentials for the user system; and
storing the assigned range of ports and the received credentials.

8. The method of claim 1, wherein the established at least one secure tunnel is utilized for a plurality of accesses to the user system.

9. The method of claim 1, further comprising:
determining a compliance state for the user system based on the collected raw data of the evidence with respect to at least one framework.

10. A non-transitory computer readable medium having stored thereon instructions for causing a processing circuitry to execute a process, the process comprising:
establishing at least one secure tunnel with a user system of a private computing infrastructure through an agent;
initiating an evidence collection over the at least one secure tunnel, wherein initiating the evidence collection further comprises fetching tunnel details;
accessing the user system via a first tunnel of the at least one secure tunnel, wherein the first tunnel is active and identified from the fetched tunnel details; and
collecting raw data of evidence from the user system.

11. A system for collecting evidence from a private computing infrastructure, comprising:
a processing circuitry; and
a memory, the memory containing instructions that, when executed by the processing circuitry, configure the system to:
establish at least one secure tunnel with a user system of the private computing infrastructure through an agent;
initiate an evidence collection over the at least one secure tunnel, wherein initiating the evidence collection further comprises fetching tunnel details;
access the user system via a first tunnel of the at least one secure tunnel, wherein the first tunnel is active and identified from the fetched tunnel details; and
collect raw data of evidence from the user system.

12. The system of claim 11, wherein the system is further configured to:
terminate the access via the first tunnel upon collection of raw data; and
purge the fetched tunnel details of the access.

13. The system of claim 11, wherein the system is further configured to:
store the raw data of the evidence in at least a portion of a data store, wherein the portion of the data store is dedicated to a tenant of the private computing infrastructure.

14. The system of claim 11, wherein the initiation of the evidence collection is based on any one of: a predetermined schedule and an on-demand request.

15. The system of claim 11, wherein the evidence includes at least one of: a policy, a standard operation procedure, an audit trail, an audit log, a training record, an incident response plan, a change management policy, a risk assessment, a third-party agreement, and a user system configuration.

16. The system of claim 11, wherein the system is further configured to:
receive a query from the agent for a network configuration at the query; and
cause the agent to activate at least one secure tunnel of the at least one established secure tunnel based on the network configuration at the query.

17. The system of claim 11, wherein establishing the at least one secure tunnel further comprises:
assign a range of ports of the at least one secure tunnel to the private computing infrastructure;
receive credentials for the user system; and
store the assigned range of ports and the received credentials.

18. The system of claim 11, wherein the established at least one secure tunnel is utilized for a plurality of accesses to the user system.

19. The system of claim 11, wherein the system is further configured to:
determine a compliance state for the user system based on the collected raw data of the evidence with respect to at least one framework.
